(19) United States
(12) Patent Application Publication
(10) Pub. No.: US 2007/0079103 A1
(43) Pub. Date: Apr. 5, 2007

(54) Method for resource management in a logically partitioned storage system

(76) Inventor: Yasuyuki Mimatsu, Cupertino, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/242,838

(22) Filed: Oct. 5, 2005

(51) Int. Cl. G06F 12/00

(52) U.S. Cl. 711/173

(57) ABSTRACT

In an apparatus, system, and method for resource management in a large, logically partitioned storage system, storage resources, such as storage capacity, ports, and cache memory are assigned to or removed from logical partitions based on results of storage management operations, I/O statistics, and user-defined policies. Thus, an administrator does not have to perform a large number of manual operations for apportionment of logically partitioned resources, thereby saving time and reducing the chance of mistakes.

### BACKGROUND OF THE INVENTION

1. Field of the Invention

The invention relates generally to a method for managing a storage system, and, more particularly, to a method for resource management in a logically partitioned storage system.

2. Description of the Related Art

US Patent Application Publication No. US 20050050085, to Shimada et al., entitled “Apparatus and Method for Partitioning and Managing Subsystem Logics”, the disclosure of which is incorporated herein by reference in its entirety, discloses a storage system which can divide its resources, such as storage capacity, ports for communicating with host computers, and cache memory into logical partitions (LPRs). Input/output (I/O) from the host computers to a volume in a logical partition (LPR) does not consume or share resources assigned to other LPRs. As a result, a change in the I/O workload in one LPR does not affect I/O performance in other LPRs. Furthermore, one LPR can be managed as if it is a small storage system. An administrator of an LPR (LPR administrator) can manage all of the resources in the LPR. For example, the LPR administrator can provision a specific volume to a host computer. The administrator of the entire storage system (storage system administrator) can create and delete LPRs and can add or remove resources to or from LPRs.

If the storage capacity, number of available ports, and/or cache memory in an LPR is exhausted, the LPR administrator asks the storage system administrator to add more resources to the LPR. The storage system administrator looks for resources which are not assigned to any LPR and assigns them to the requesting LPR with exhausted resources. When all of the resources needed by the LPR in the storage system are already assigned to other LPRs, the storage system administrator has to look for resources which are not being used by the LPR to which they are assigned and remove them from that LPR before reassigning them to the requesting LPR. However, as storage systems increase in size and have a large number of resources, these types of manual operations become time-consuming and can easily result in erroneous operations in addition to time delays and increased costs of operation.

### BRIEF SUMMARY OF THE INVENTION

An object of the invention is to provide a method and system which eliminates most of the manual operations in an LPR management process by automatically adding or removing resources to or from LPRs.

According to one aspect of the present invention, in a logically partitioned storage system, storage resources, such as storage capacity, ports, and cache memory are assigned to or removed from logical partitions based on results of storage management operations, I/O statistics, and user-defined policies. This relieves the storage system administrator from having to perform a large number of manual operations for managing and apportioning resources, thereby saving time and reducing the chance of mistakes.

These and other objects, features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration of the invention according to one embodiment.

FIG. 2 illustrates an example of logical partitions.

FIG. 3 illustrates an example of a main volume table.

FIG. 4 illustrates an example of a main port table.

FIG. 5 illustrates an example of a main cache memory table

FIG. 6 illustrates an example of an access control table.

FIG. 7 illustrates an example of an LPR volume table.

FIG. 8 illustrates an example of an LPR port table.

FIG. 9 illustrates an example of an LPR cache memory table.

FIG. 10 illustrates an example of a volume policy table.

FIG. 11 illustrates an example of a port policy table.

FIG. 12 illustrates an example of a cache memory policy table.

FIG. 13 is a flowchart illustrating an I/O process and table update.

FIG. 14 is a flowchart illustrating a management session.

FIG. 15 is a flowchart illustrating volume provisioning in an LPR.

FIG. 16 is a flowchart illustrating volume unprovisioning in an LPR.

FIG. 17 is a flowchart illustrating policy management.

FIG. 18 is a flowchart illustrating updating port usage.

FIG. 19 is a flowchart illustrating updating cache hit ratio.

FIG. 20 is a flowchart illustrating maintaining volume policy.

FIG. 21 is a flowchart illustrating adding volumes to an LPR.

FIG. 22 is a flowchart illustrating removing volumes from an LPR.

FIG. 23 is a flowchart illustrating maintaining port policy.

FIG. 24 is a flowchart illustrating adding ports to an LPR.

FIG. 25 is a flowchart illustrating removing ports from an LPR.

FIG. 26 is a flowchart illustrating maintaining cache memory policy.

FIG. 27 is a flowchart illustrating adding cache memory to an LPR.

FIG. 28 is a flowchart illustrating removing cache memory from an LPR.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

System Structure

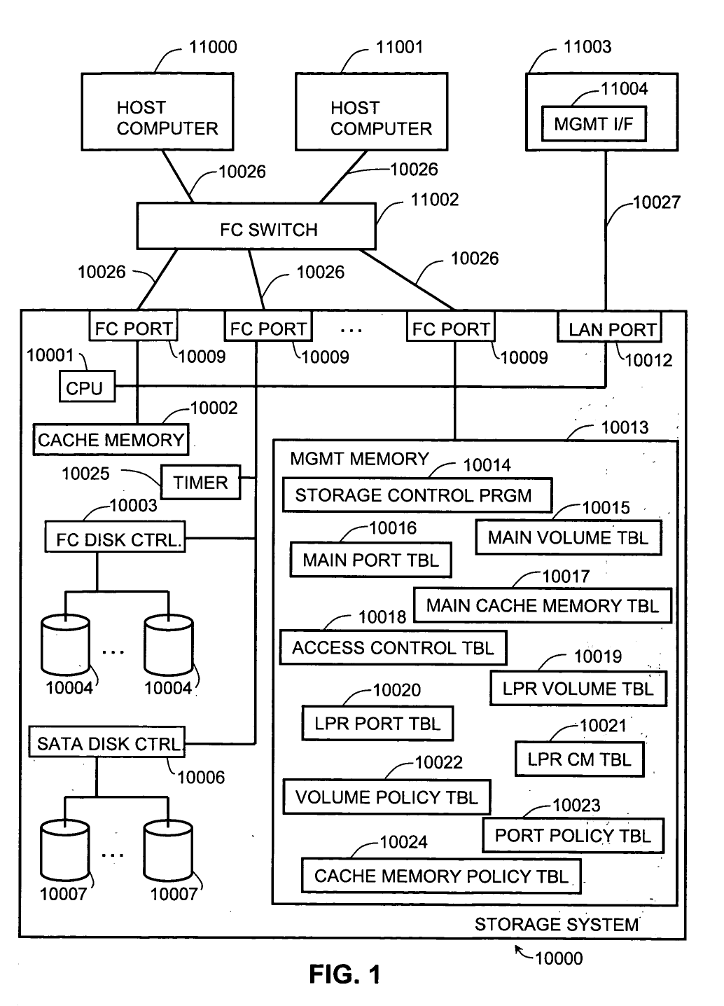

FIG. 1 illustrates a computer storage system in which the method and apparatus of this invention are applied. Host computers 11000 and 11001, Fibre Channel (FC) switch 11002, and storage system 10000 are connected by FC cables 10026 attached to FC ports 10009. Host computers 11000 and 10001 read and write data from and to storage system 10000 through the FC network, which includes FC switch 11002 and FC ports 10009.

A storage system and management console 11003 is connected to storage system 10000 by a local area network (LAN) 10027 via a LAN port 10012. Management console 11003 has a management interface (MGMT I/F) 11004 to allow an administrator to communicate with storage system 10000. By using the management interface 11004, an administrator is able to browse management information in storage system 10000 and send instructions to manage storage system 10000 through the LAN 10027.

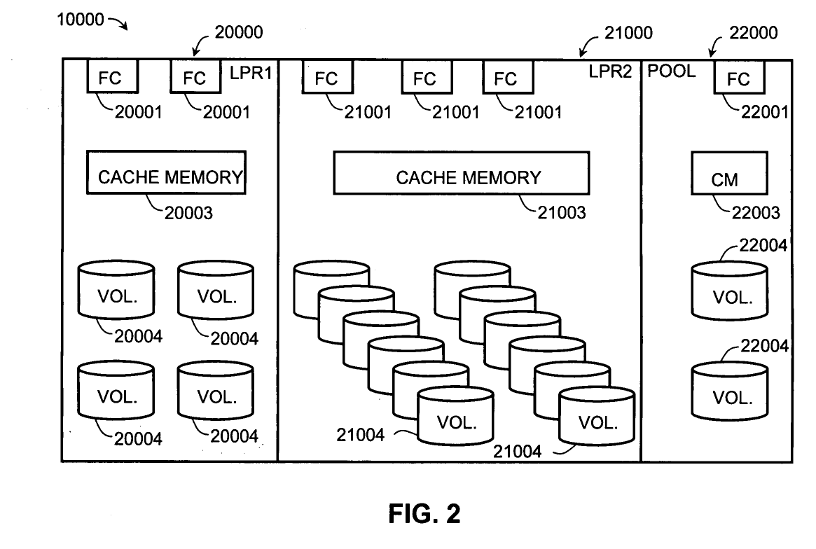

Storage system 10000 provides one or more logical partitions (LPRs), each operable as an individual storage system. In FIG. 2, reference numerals 20000 and 21000 indicate first and second logical partitions (LPR1, LPR2), respectively, and reference number 22000 indicates a pool of resources which are not currently assigned to any LPR. Resources allocated to first LPR 20000 (LPR1) include FC ports 20001, cache memory (CM) 20003, and logical volumes 20004. Similarly, resources allocated to second LPR 21000 (LPR2) include FC ports 21001, cache memory 21003, and logical volumes 21004. Resources remaining in resource pool 22000 include FC port 22001, cache memory 22003, and logical volumes 22004. Further, while only two LPRs are illustrated, it will be apparent to those skilled in the art that a larger number of LPRs may be created, depending on available resources, size of the LPRs, and the like.

In the example illustrated, each LPR 20000, 21000 has an LPR administrator who can manage any resource in the LPR. An I/O request which is sent from a host computer authorized to access an LPR to a disk volume (such as volumes 20004 in the first LPR 20000) is processed by using an FC port, such as FC ports 20001, and a cache memory, such as cache memory 20003, in the same LPR.

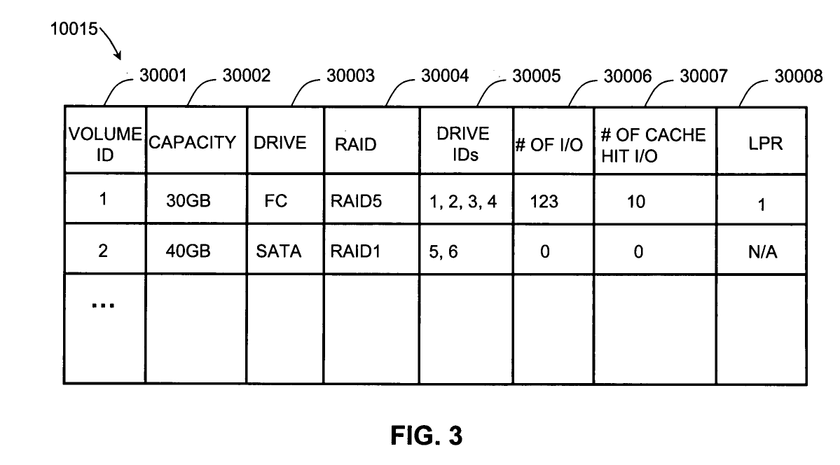

Referring once again to storage system 10000 in FIG. 1, CPU 10001 executes a storage control program 10014 which is stored in a management memory 10013, or other computer-readable medium. Storage control program 10014 processes I/O requests sent from host computers 11000 and 11001, manages logical partitions (LPRs) and resources in the storage system based on policies defined by storage administrator, and communicates with the management console 11003. FC disk controller 10003 controls I/O to and from FC disk drives 10004 which are expensive and can provide high performance to host computers. Serial ATA (SATA) disk controller 10006 controls I/O to and from SATA disk drives 10007 which are inexpensive and can provide large capacity. Data from the host computers or disk drives are stored in cache memory 10002 to shorten response time and increase throughput. A timer 10025 allows storage control program 10014 to read the current time and perform scheduled processes. According to one embodiment of the present invention, memory 10013 may include ten tables used by storage control program 10014 to manage LPRs and storage resources. Each of these tables is described below in connection with FIGS. 3-12. Further it should be noted that while management memory 10013 and cache memory 10002 are illustrated as being separate, they may be a single memory, or many different memories.

FIG. 3 illustrates a main volume table 10015, which contains information about all disk volumes in the storage system. Each line in main volume table 10015 contains the volume ID 30001 which is a unique number, volume capacity 30002, type of disk drives which compose the volume 30003, RAID level 30004, Drive IDs 30005 of the disk drives, number of I/Os issued to the volume 30006, number of I/O requests which accessed data stored in the cache memory 30007 without accessing disk drives, and ID of any LPR to which the volume is assigned 30008.

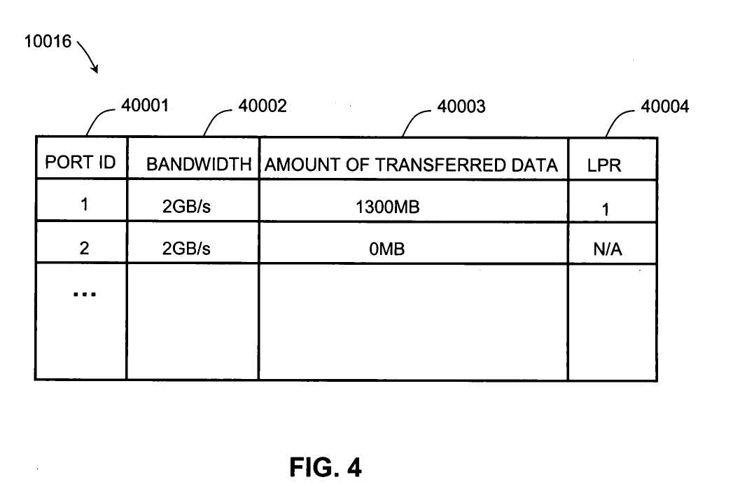

FIG. 4 illustrates a main port table 10016, which contains information about all FC ports in the storage system. Main port table 10016 contains the port ID 40001, port bandwidth 40002, amount of data transferred through the port 40003, and ID of the LPR to which the port is assigned 40004.

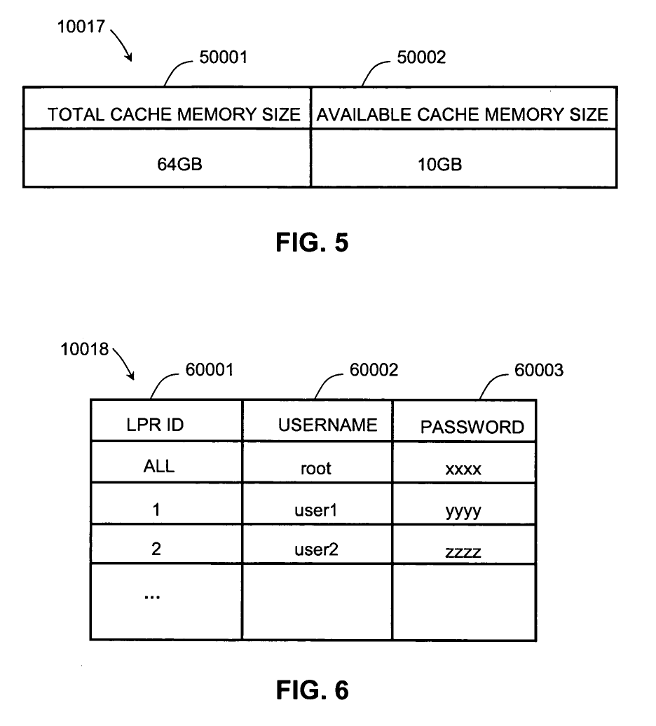

FIG. 5 illustrates a main cache memory table 10017, which contains information about the cache memory in the storage system. Columns 50001 and 50002 indicate the total cache memory size and the size of cache memory which is not assigned to any LPR, respectively.

FIG. 6 illustrates an access control table 10018, which contains information about all accounts of administrators. Access control table 10018 contains the ID of the LPR which an administrator is allowed to manage 60001, as well as the username 60002 and password 60003, which are used to authenticate the administrator.

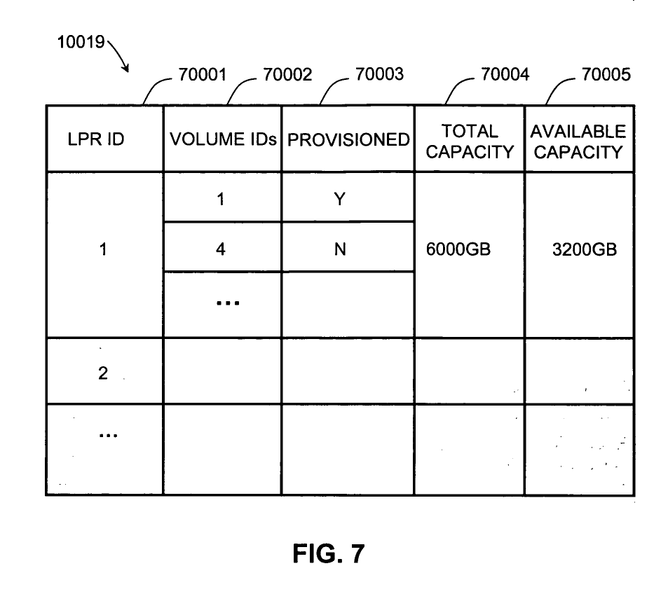

FIG. 7 illustrates an LPR volume table 10019, which contains information about volumes which are assigned to each LPR. LPR volume table 10019 contains the LPR ID 70001, IDs of volumes which are assigned to the LPR 70002, state of the volumes 70003, which indicates whether or not a volume is mapped to one or more ports (i.e., whether or not it is “provisioned”), total capacity of all volumes which are assigned to the LPR 70004, and capacity of volumes which are not currently provisioned 70005. In the state of the volumes 70003, Y means that the volume is already mapped to one or more ports. N means that the volume is not yet mapped to any port (not provisioned). As described in connection with FIG. 10 below, which illustrates a volume policy table 10022, if the lower threshold of the LPR is “On Demand”, the available capacity 70005 contains the total capacity of volumes which are not assigned to any LPR in the storage system.

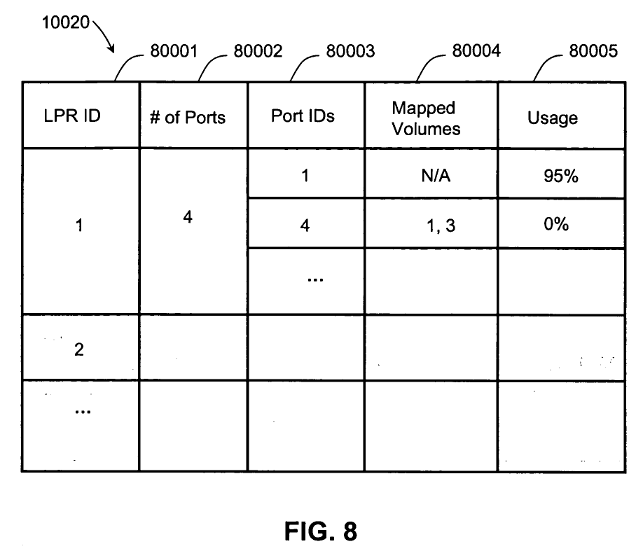

FIG. 8 illustrates an LPR port table 10020, which contains information about ports which are assigned to each LPR. LPR port table 10020 contains the LPR ID 80001, total number of ports which are assigned to the LPR 80002, port IDs of the ports 80003, IDs of volumes which are mapped to the port 80004, and the ratio of bandwidth usage 80005.

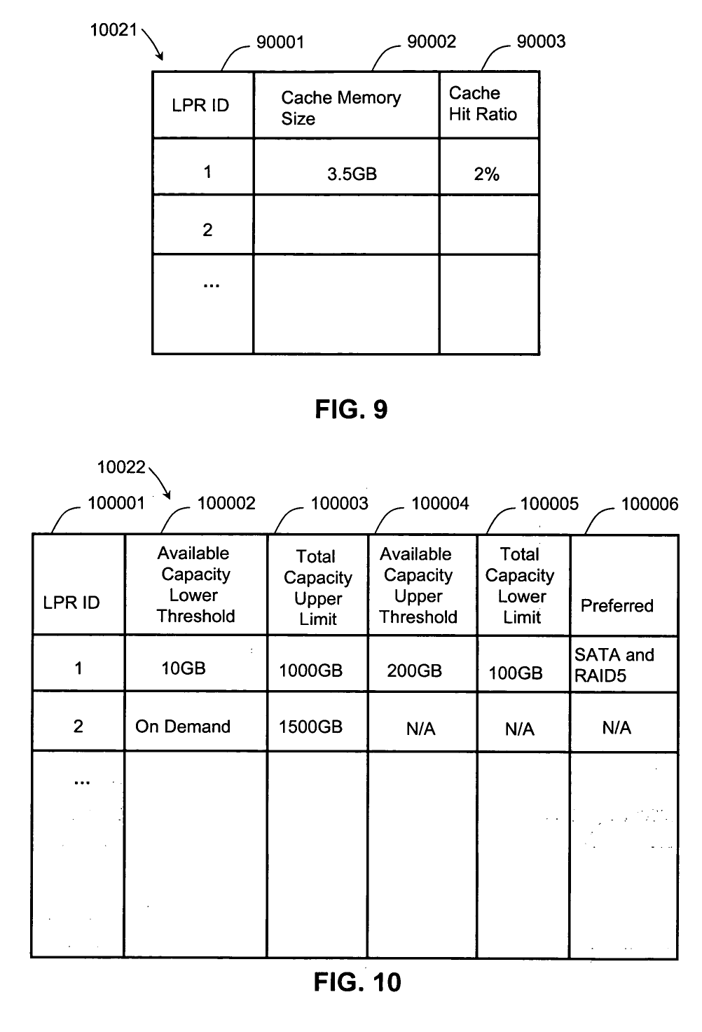

FIG. 9 illustrates an LPR cache table 10021, which contains information about the cache memory which is assigned to each LPR. LPR cache table 10021 contains the LPR ID 90001, size of the cache memory which is assigned to the LPR 90002, and the ratio of cache hits for I/O requests which access disk volumes in the LPR 90003.

FIG. 10 illustrates a volume policy table 10022, which contains information about the volume assignment policy of each LPR. Volume policy table 10022 contains the LPR ID 100001, an available capacity lower threshold 100002, a total capacity upper limit 100003, an available capacity upper threshold 100004, a total capacity lower limit 100005 and preferred kinds of disk volumes 100006. The lower threshold 100002, upper limit 100003, and preferred field 100006 define the policy of adding disk volumes to the LPR. Basically, storage control program 10014 may maintain the available capacity of an LPR at a point between more than or equal to the available capacity lower threshold 100002 and less than or equal to the available capacity upper threshold 100004. Storage control program 10014 also maintains the total capacity of the LPR at less than or equal to total capacity upper limit 100003 and more than or equal to lower limit 100005. If the available capacity lower threshold 100002 is specified and available capacity, that is, capacity of volumes which are not mapped to any port in the LPR is less than the specified lower threshold 100002, storage control program 10014 attempts to add more disk volumes to the LPR. Storage control program 10014 selects volumes to be added from volumes which satisfy the conditions specified in ‘preferred’ field 100006, if possible. However, storage control program 10014 also maintains the total capacity in the LPR at a point less than or equal to the total capacity upper limit 100003, if an upper limit is specified. The available capacity upper threshold 100004 and total capacity lower limit 100005 define the policy of removing disk volumes from the LPR. If the available capacity upper threshold 100004 is specified and the available capacity is more than the specified capacity, storage control program 10014 tries to remove disk volumes from the LPR so that they can be added to other LPRs. However, storage control program 10014 also maintains the total capacity in the LPR at a point that is greater than or equal to the total capacity lower limit 100005, if it is specified. Furthermore, an available capacity lower threshold 100002 of “On Demand” refers to a special policy, wherein LPR volume table 10019 contains all disk volumes which are not assigned to any LPR in addition to volumes which are assigned to the LPR. An LPR administrator of the LPR can manage all disk volumes except disk volumes which are assigned to other LPRs. For administrators of LPRs which have a lower threshold set as “On Demand”, free disk volumes are shared. If a free disk volume is mapped to a port in an LPR by an administrator of the LPR, storage control program 10014 assigns the volume to the LPR. In an LPR which has an available capacity lower threshold 100002 set as “On Demand”, the available capacity upper threshold and total capacity lower limit are not used, and the available capacity in the LPR volume table 10019 contains the total capacity of volumes which are not assigned to any LPR. A disk volume which is assigned to an LPR and not mapped to any port is removed automatically from the LPR by storage control program 10014.

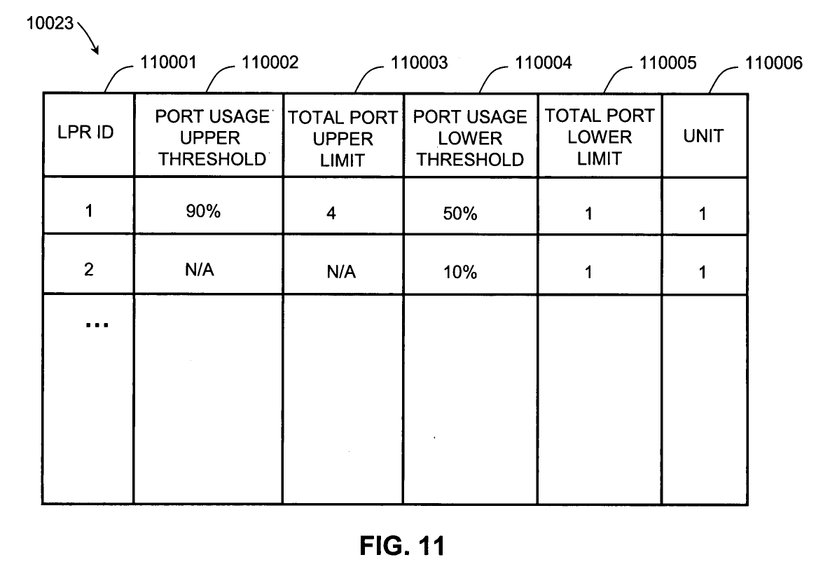

FIG. 11, illustrates a port policy table 10023, which contains information about the port assignment policy of each LPR. Port policy table 10023 contains the LPR ID 110001, a port usage upper threshold 110002, a total port upper limit 110003, a port usage lower threshold 110004, a total port lower limit 110005, and number of ports (unit) 110006 which are assigned to or removed from the LPR at a time by storage control program 10014. Basically, storage control program 10014 tries to maintain the average of port usage in an LPR at a point that is greater than or equal to the port usage lower threshold 110004 and less than or equal to the port usage upper threshold 110002. Storage control program 10014 also maintains the total number of ports in the LPR at a point that is less than or equal to the total port upper limit 110003 and greater than or equal to the total port lower limit 110005. The port usage upper threshold 110002 and total port upper limit 110003 define the policy of adding ports to the LPR. If the port usage upper threshold 110002 is specified, and average usage ratio of all ports which are assigned to the LPR is more than the specified ratio, storage control program 10014 attempts to add more ports to the LPR so that an administrator of the LPR can modify the mapping of volumes and ports to distribute I/O workload to the new ports. The total port upper limit 110003 is the maximum number of ports which are assigned to the LPR. The port usage lower threshold 110004 and total port lower limit 110005 define the policy of removing ports from the LPR. If port usage lower threshold 110004 is specified and average usage ratio of all ports in the LPR is less than the specified ratio, storage control program 10014 tries to remove ports to which no volumes are mapped. Total port lower limit 110005 is the minimum number of ports in the LPR.

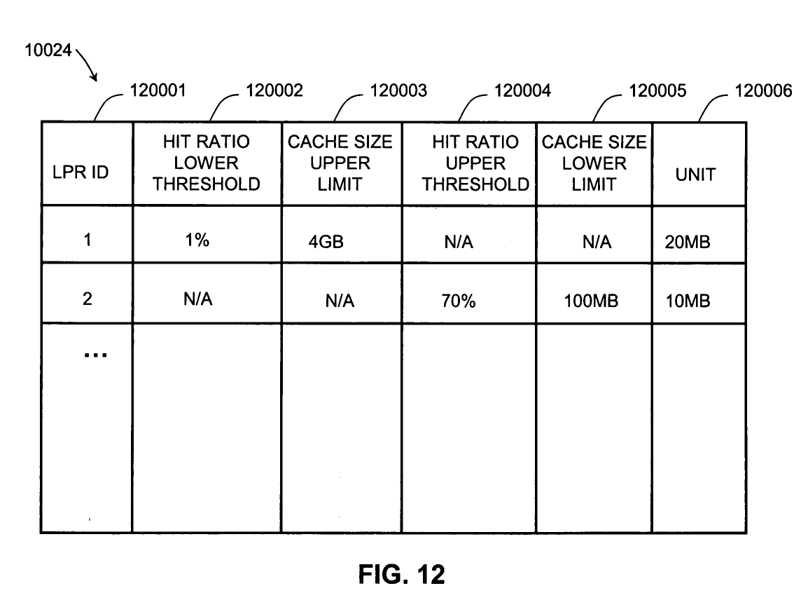

FIG. 12 illustrates a cache memory policy table 10024, which contains information about the cache memory assignment policy of each LPR. Cache memory policy table 10024 contains the LPR ID 120001, a hit ratio lower threshold 120002, a cache size upper limit 120003, a hit ratio upper threshold 120004, a cache size lower limit 120005, and size of cache memory (unit) 120006 which is assigned to or removed from the LPR at a time by storage control program 10014. Basically, storage control program 10014 tries to maintain the cache hit ratio of an LPR at a point that is greater than or equal to hit ratio lower threshold 120002 and less than or equal to hit ratio upper threshold 120004. Storage control program 10014 also maintains the cache memory size of the LPR at a point that is less than or equal to cache size upper limit 120003 and greater than or equal to cache size lower limit 120004. Hit ratio lower threshold 120002 and cache size upper limit 120003 define the policy of adding cache memory to the LPR. If hit ratio lower threshold 120002 is specified, and the cache hit ratio of I/Os which access disk volumes in the LPR is less than the specified ratio, storage control program 10014 tries to add more cache memory to the LPR. Cache size upper limit 120003 is the maximum size of cache memory in the LPR. Hit ratio upper threshold 120004 and cache size lower limit 120005 define the policy of removing cache memory from the LPR. If hit ratio upper threshold 120004 is specified, and cache hit ratio is more than the specified ratio, storage control program 10014 tries to remove cache memory from the LPR. Cache size lower limit 120005 is the minimum size of cache memory in the LPR.

I/O Process

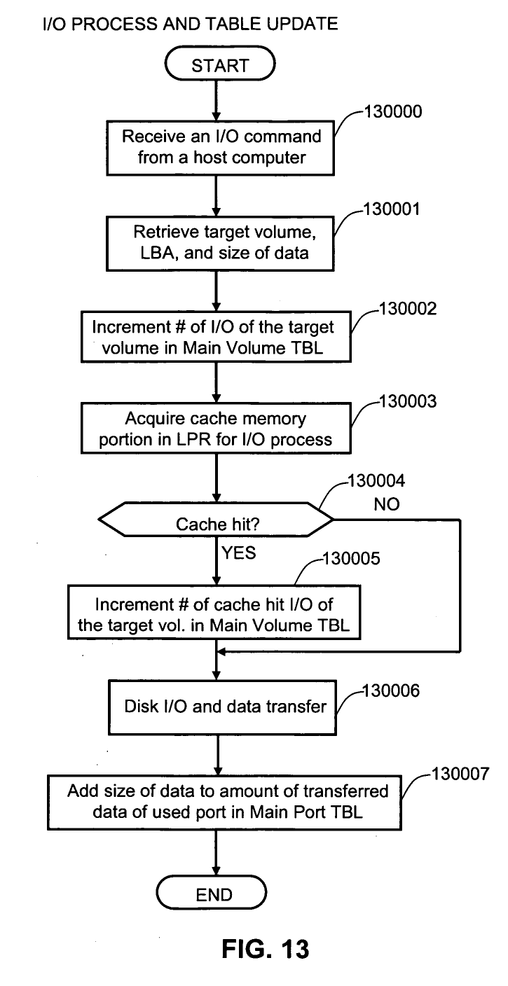

Storage control program 10014 updates tables when it processes I/O requests. FIG. 13 shows the process flow executed by storage control program 10014 to process I/O requests and update tables. When storage control program 10014 receives an I/O command from a host computer (step 130000), the storage control program 10014 retrieves a target disk volume, location of data to be accessed in the volume (LBA: Logical Block Address), and size of data from the command (step 130001). Program 10014 increments the number of I/Os sent to the target volume in main volume table 10015 (step 130002). When storage control program 10014 tries to acquire the cache memory portion to store the data, storage control program 10014 examines whether or not the data to be accessed already exists in the cache memory 10002 (step 130003). If the data exists in the cache memory 10002 (step 130004), the storage control program 10014 increments the number of cache hit I/Os 30007 of the target volume in the main volume table 10015 (step 130005). It also adds size of data to the amount of transferred data field 40003 of the used port in main port table 10016 (step 130007).

Management Session

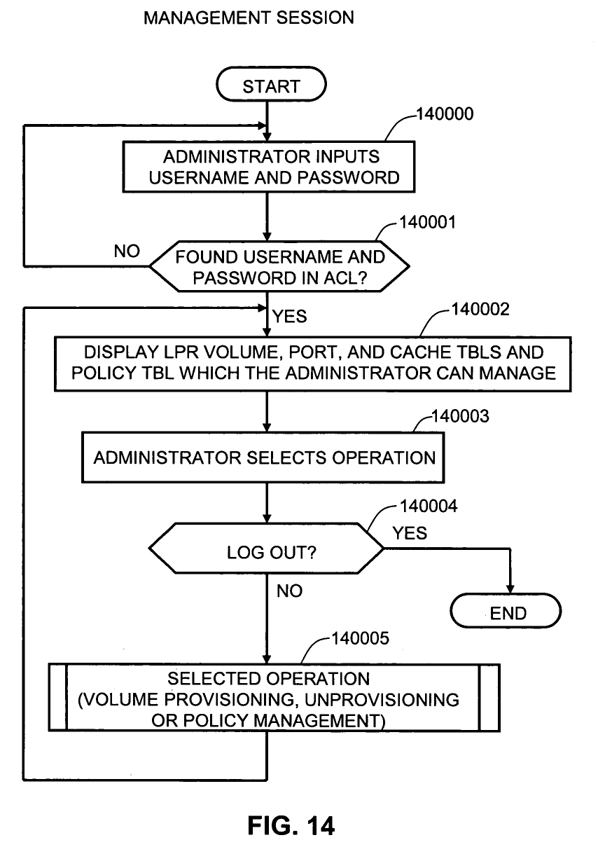

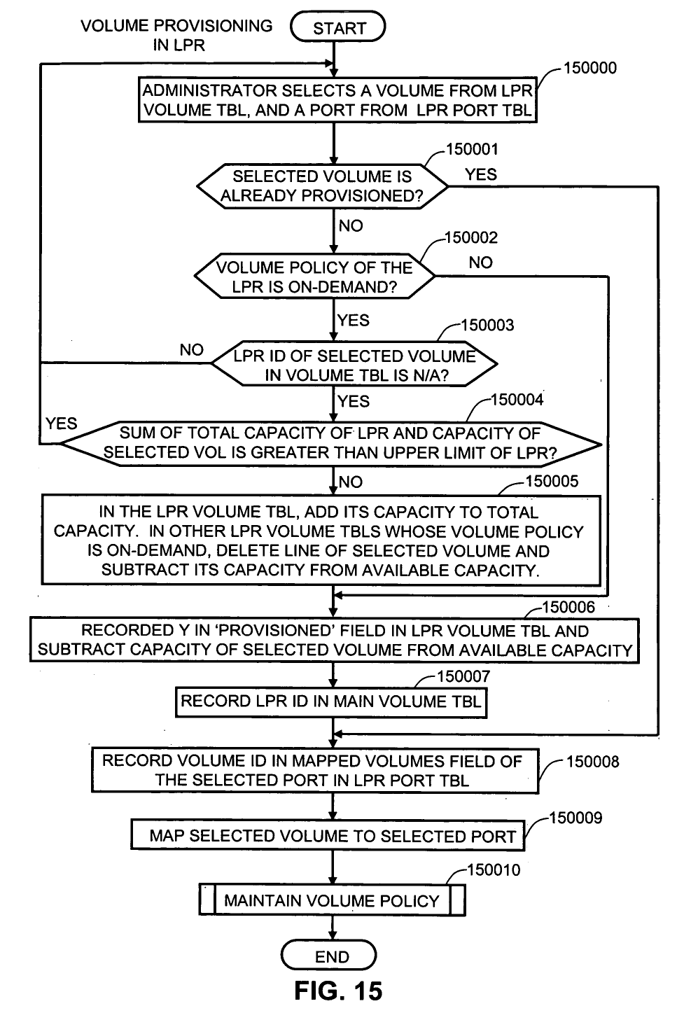

An administrator may manage an individual LPR or the entire storage system by using the management interface 11004. FIG. 14 shows an example of the process flow of the management session. Initially, an administrator inputs a username and password to log in to the storage system (step 140000). If there is an account which has the username and password in the access control table 10018 (step 140001), the administrator is allowed to manage the LPR whose ID 70001 is recorded in the access control table 10018 (step 140002). By selecting an operation in the management interface (step 140003), the administrator can perform one or more of various operations (step 140005). If the selected operation is to log out (140004), the session finishes. Three operations shown in step 140005 are: volume provisioning, volume unprovisioning, and policy management. These operations are explained below in conjunction with FIGS. 15-17.

FIG. 15 illustrates the process flow of volume provisioning in an LPR. If an administrator selects a volume to be provisioned from LPR volume table 10019 and a port to which the volume mapped to from LPR port table 10020 (step 15000), storage control program 10014 checks whether the volume is already provisioned or not by looking up the “provisioned” field 70003 in LPR volume table 10019 (step 150001). If the volume is already provisioned, the process goes to step 150008. Otherwise, storage control program 10014 checks whether or not the volume policy of the LPR is “On Demand” or not (step 150002). If it is not “On Demand”, the process continues to step 150006. Otherwise, storage control program 10014 ensures that the volume is not selected by an administrator of another LPR simultaneously (step 150003). Storage control program 10014 also ensures that the total capacity of the LPR does not exceed the specified upper limit by provisioning the selected volume (step 150004). If an LPR has the volume policy of “On Demand”, the volume is assigned to the LPR when it is provisioned by an administrator of the LPR. So, the capacity is added to the total capacity of the LPR. In any other LPRs which have the volume policy of “On Demand”, their available capacity is subtracted accordingly and the lines corresponding to the volume are deleted (step 150005). In step 150006, the “provisioned” field of the volume in LPR volume table 10019 is changed to ‘Y’ and available capacity of the LPR is subtracted by the capacity of the volume. To indicate that the volume is assigned to the LPR, the LPR ID is recorded in the line of the volume in main volume table 10015 (step 150007). To indicate that the volume is mapped to the selected port, the volume ID is recorded in the line of the port in LPR port table 10020 (step 150008). In step 150009, storage control program 10014 executes actual mapping process. After the volume mapping is changed, storage control program 10014 checks whether the volume policy is kept. If it is not kept, it executes necessary processing, as explained further below (step 150010).

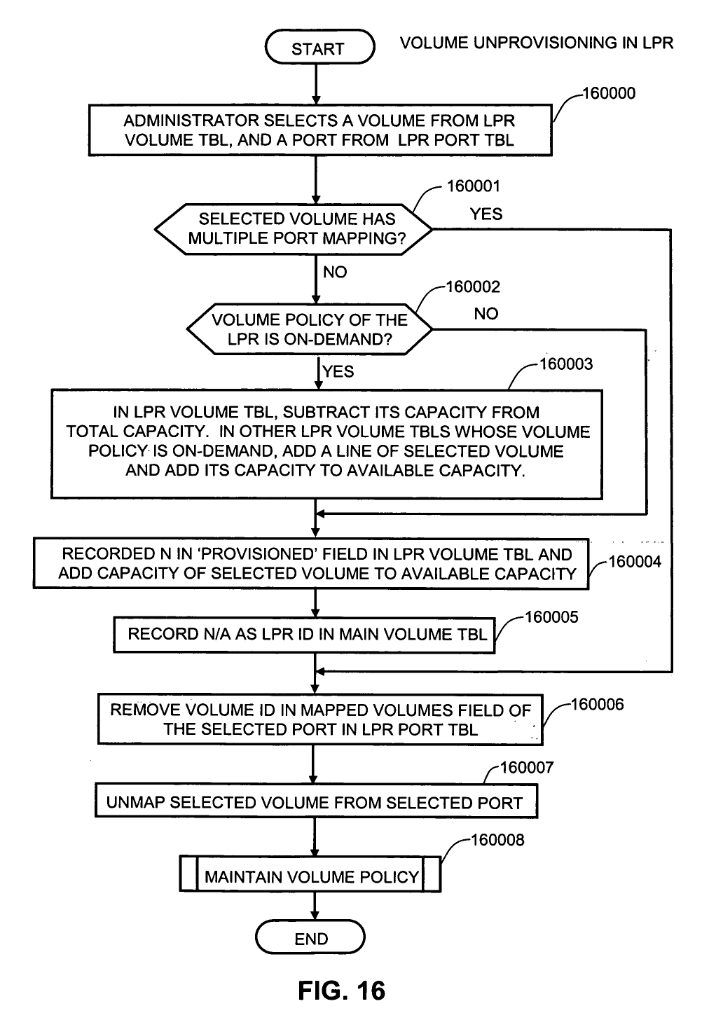

FIG. 16 illustrates the process flow of volume unprovisioning in an LPR. This is basically a reverse process of volume provisioning described above. An administrator selects a volume from the LPR volume table and a port from the LPR port table 10020 (step 160000). Storage control program 10014 determines if the selected volume has multiple port mappings (step 160001) and whether the volume policy of the LPR is “On Demand” (step 160002). If a volume to be unprovisioned has only one mapping to a port, and the LPR has a volume policy of “On Demand”, the volume is removed from the LPR to be shared by other LPRs as a free volume. Thus, in the LPR volume table 10019, the volume's capacity is subtracted from the total capacity, and in the LPR volume table for other LPRs whose volume policy is “On Demand”, a line is added for the selected volume, and the volume's capacity is added to the available capacity (step 160003). Further an “N” is recorded in the “provisioned” field 70003 in the LPR volume table 10019, and the capacity of the selected volume is added to the available capacity (step 160004). Also, “N/A” is recorded in as an LPR ID in the main volume table 10015 (step 160005). Next, the selected volume ID is removed from the mapped volumes field for the selected port in the LPR port table 10020 (step 160006). The selected volume is unmapped from the selected port (step 160007) and a determination is made whether to keep the current volume policy (step 160008). Also, in the process flow of volume unprovisioning, a step corresponding to step 150004 in FIG. 15 does not exist because there is no restriction defined by the volume policy to remove volumes from an LPR which has “On-Demand” policy.

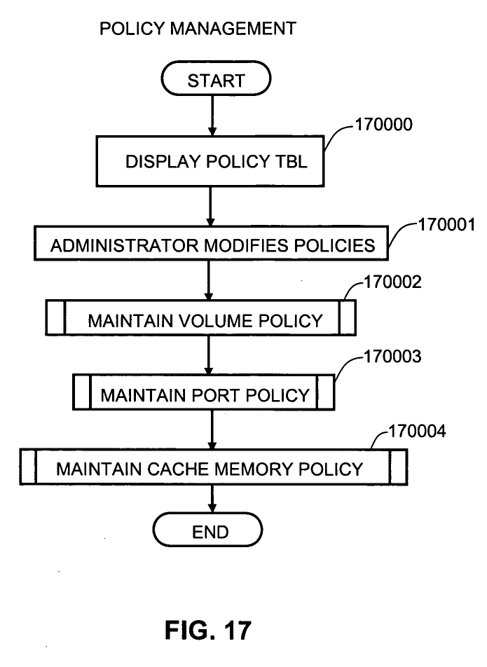

FIG. 17 shows the process flow of policy management in the storage system. After an administrator browses the current policies (step 170000) and modifies them (step 170001), that is, the contents of volume policy table 10022, port policy table 10023, or cache memory policy table 10024 are modified, storage control program 10014 checks whether policies are maintained (steps 170002-170004) and executes necessary processes to maintain them, as will be explained in more detail below.

Frequent Usage Update Process

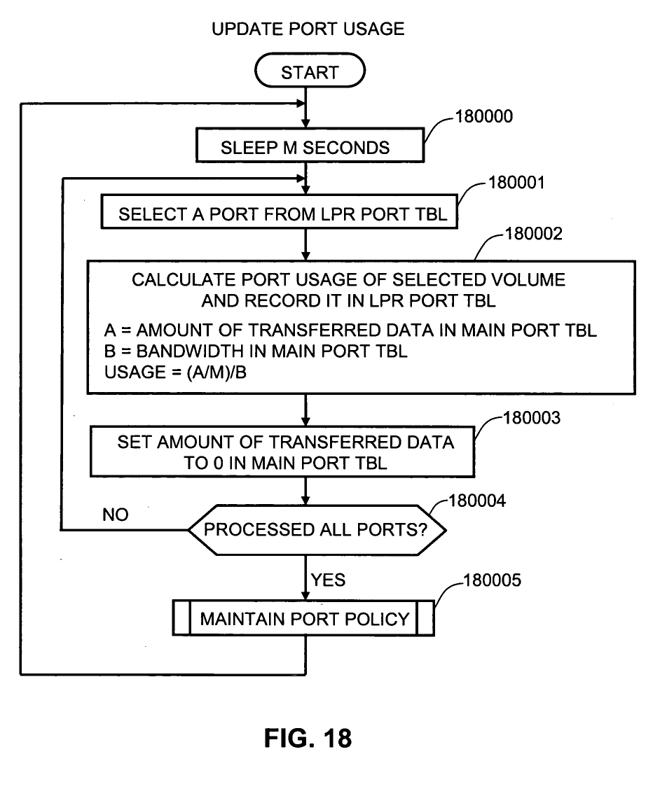

Information about port usage ratio and cache hit ratio are updated frequently based on the amount of transferred data of each port and number of total cache hit I/Os in each LPR. FIG. 18 shows the process flow for port usage ratio update executed by storage control program 10014. The process is executed each “M” seconds (step 180000), where M is a user-defined or fixed value. For each port (step 180001), usage ratio in the previous M seconds is calculated by the formula in step 180002 (namely, A=amount of transferred data, B=Bandwidth, whereby usage=(A/M)/B), and recorded in the line of the port in LPR port table 10020. To record the I/O activity in the next M seconds, the amount of transferred data is set to 0 in main port table 10016 (step 180003). Steps 180001-180003 are repeated for each port (step 180004). After updating port usage, storage control program 10014 checks whether the port policy is maintained and executes necessary processes to maintain it as will be explained in more detail below (step 180005).

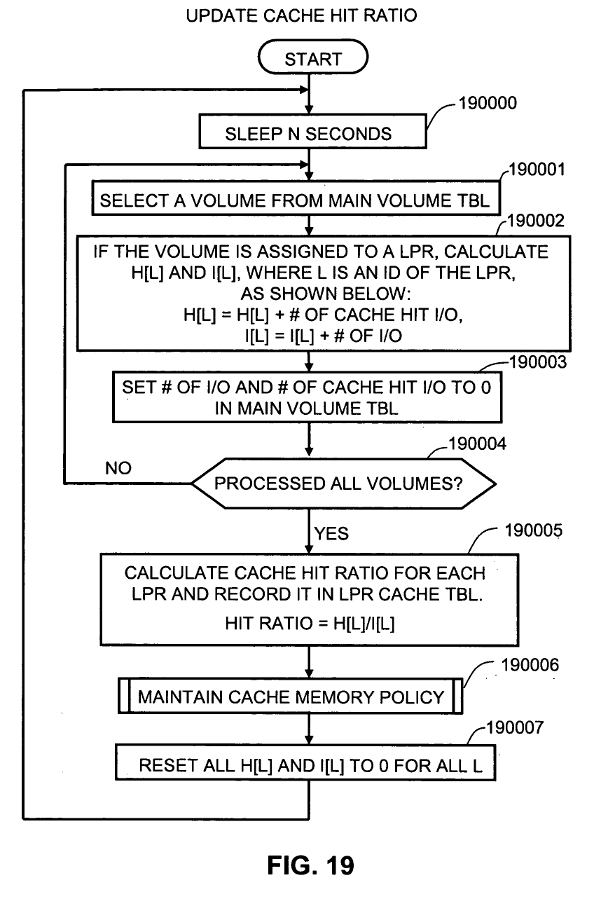

FIG. 19 shows the process flow of cache hit ratio update executed by storage control program 10014. The cache hit ratio is checked every “N” seconds (step 190000). In steps 190001-190004, storage control program 10014 sums up the number of cache hits and total I/Os for each LPR. The number of cache hits and total I/Os for each LPR are represented by H[L] and I[L], respectively, where L is an ID of the LPR. For each volume (step 190001), if the volume is assigned to an LPR, the number of cache hits recorded and the number of total I/Os which are recorded in LPR volume table, are added to H[L] and I[L], respectively (step 190002). Once all volumes have been processed (step 190004), the cache hit ratio for each LPR is calculated by expression in step 190005, (namely, hit ratio =H[L]/I[L], where H[L] is the number of cache hits in an LPR, I[L] is the number of total I/Os in an LPR, and L is an ID of the LPR), and stored in LPR cache memory table 10021. Storage control program 10014 determines if the cache memory policy is maintained after updating the ratio (step 190006). In step 190007, H(L) and I(L) are reset to zero for use in calculating the cache hit ratio during the next time period N.

Maintaining Volume, Port and Cache Policies

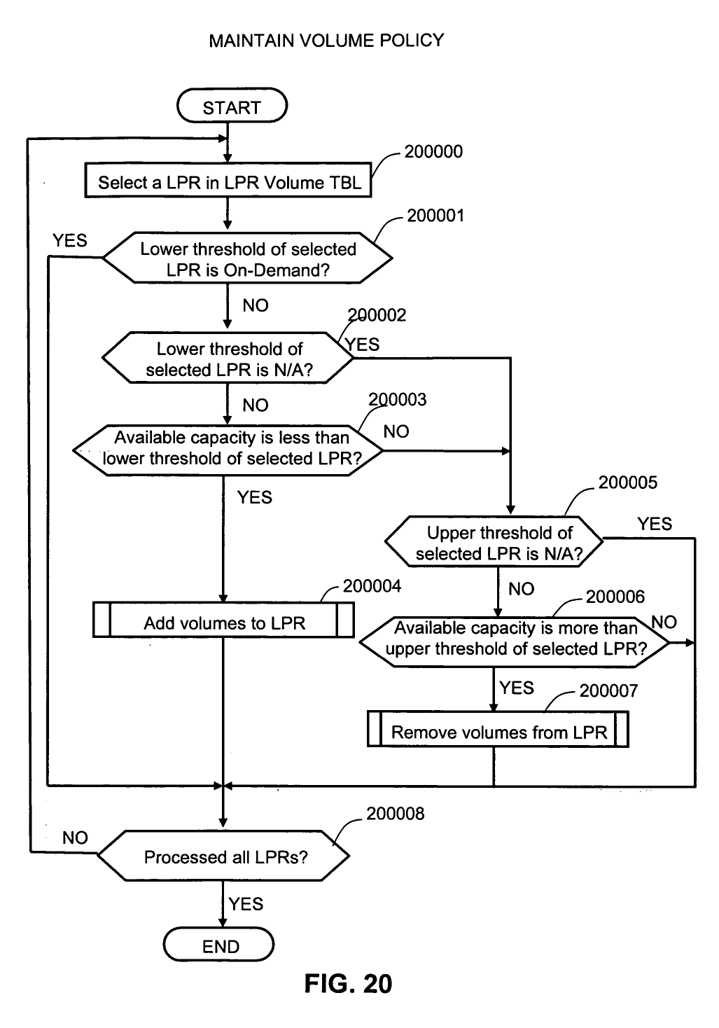

FIG. 20 shows the flow of a process for maintaining a volume policy, whereby the storage control program 10014 checks each LPR to ensure that the volume policy for each LPR is being maintained as specified. For each selected LPR (step 200000), storage control program 10014 checks whether the available capacity lower threshold is set to “On Demand” (step 200001). If it is set to “On Demand”, the process continues to step 200008. Otherwise, storage control program 10014 checks whether or not the available capacity lower threshold of the LPR is specified (step 20002). If specified, and if the available capacity of the LPR is less than the available capacity lower threshold (step 200003), storage control program 10014 tries to add disk volumes to the LPR (step 200004). Otherwise, storage control program 10014 checks whether or not the available capacity upper threshold of the LPR is specified (step 200005). If it is specified, and if the available capacity of the LPR is more than the available capacity upper threshold (step 200006), storage control program 10014 tries to remove volumes from the LPR (step 200007). Steps 200000-200007 are repeated for each LPR (step 200008).

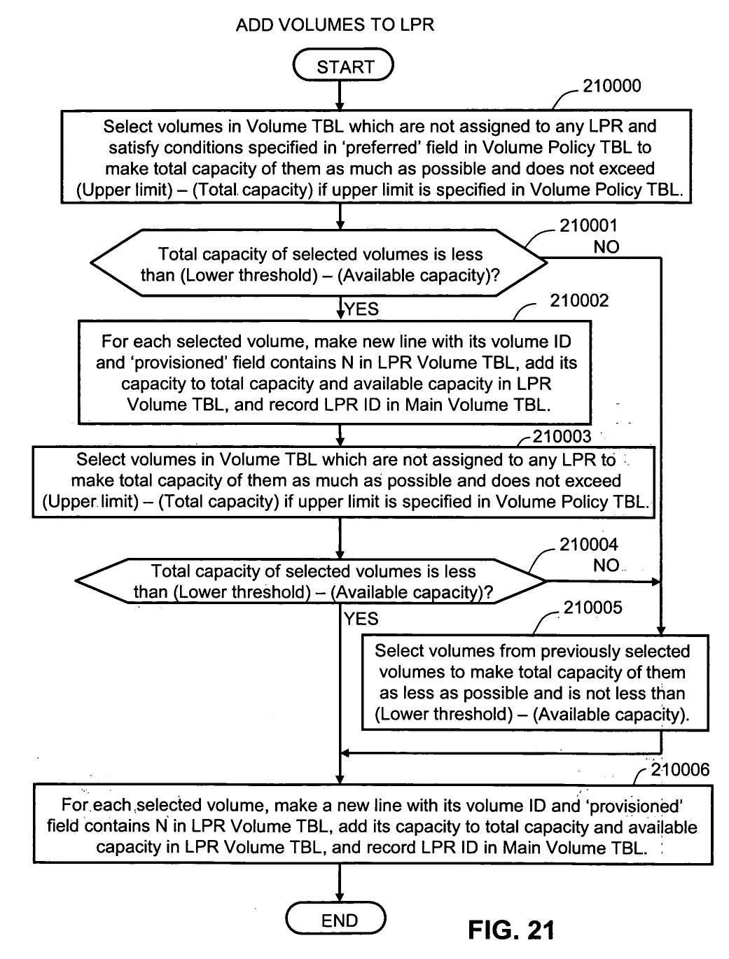

The details the process of step 200004 of FIG. 20 for adding volumes to an LPR are illustrated in FIG. 21. In step 210000, storage control program 10014 selects as many volumes as possible, which are free and satisfy conditions specified in the “preferred” field in the line of the LPR in volume policy table 10022, and their total capacity does not exceed the differential of total capacity upper limit and total capacity of the LPR. If the total capacity of selected volumes is enough to fill the differential between the specified available capacity lower threshold and the current available capacity (step 210001), the process goes to step 210005. Otherwise, storage control program 10014 assigns all of the selected volumes to the LPR (step 210002) and then selects all volumes which are free and do not satisfy conditions specified in ‘preferred’ field (step 210003). If the total capacity of newly-selected volumes is enough to fill the differential between the available capacity lower threshold and the current available capacity (step 210004), storage control program 10014 selects volumes from the selected volumes that provide enough capacity to fill the differential between the available capacity lower threshold and the current available capacity (step 210005). Finally, storage control program 10014 assigns the selected volumes to the LPR (step 210006).

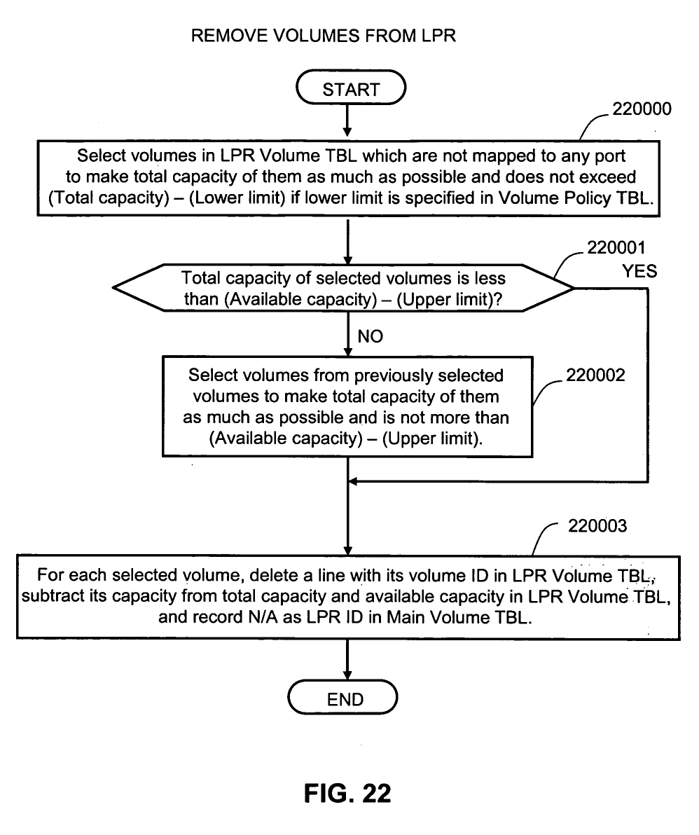

The details the process of step 200007 of FIG. 20 for removing volumes from an LPR are illustrated in FIG. 22. In step 220000, for the particular LPR, storage control program 10014 selects as many volumes as possible, which are not provisioned to any port from the LPR volume table 10019, and such that, their total capacity does not exceed the differential between the total capacity of the LPR and the total capacity lower limit. If the total capacity of selected volumes is insufficient to fill the differential of available capacity of the LPR and the LPR's total capacity upper limit (step 220001), the process proceeds to step 220003. Otherwise, storage control program 10014 selects volumes from the selected volumes enough to fill the differential of available capacity of the LPR and total capacity upper limit (step 220002). Finally, storage control program 10014 removes selected volumes from the LPR (step 220003).

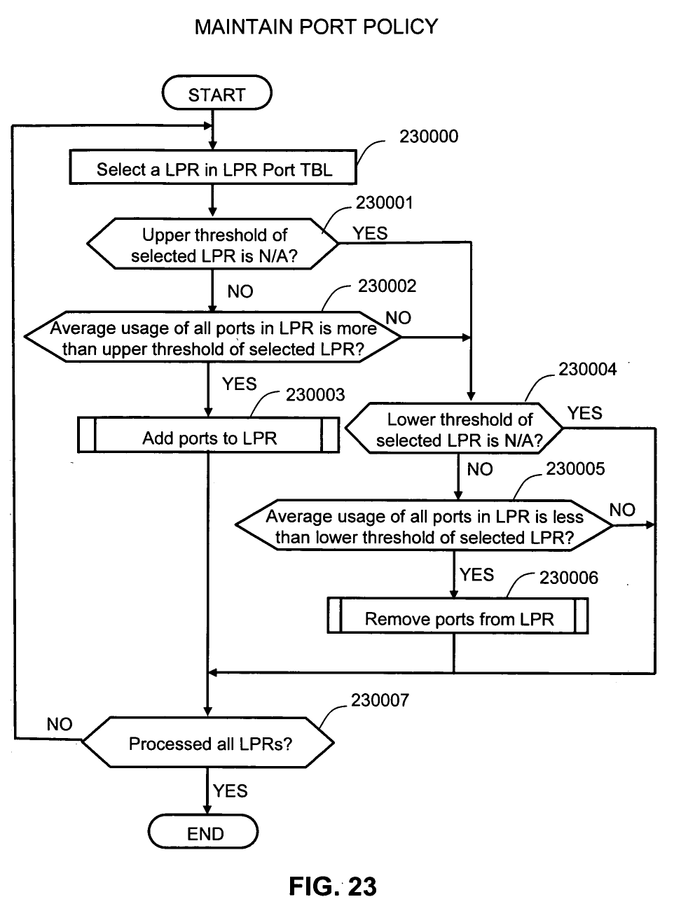

FIG. 23 illustrates the process flow for maintaining the port policies for the LPRs. For each selected LPR (step 230000), storage control program 10014 checks whether the upper and lower port usage thresholds are specified or not (steps 230001 and 230004, respectively). If the port usage upper threshold is specified and the average usage ratio of port is more than the port usage upper threshold (step 230002), storage control program 10014 attempts to add ports (step 230003). If the port usage lower threshold is specified and the average usage ratio of port is less than the port usage lower threshold (step 230005), storage control program 10014 tries to remove ports (step 230006). The process repeats until all LPRs have been selected (step 230007).

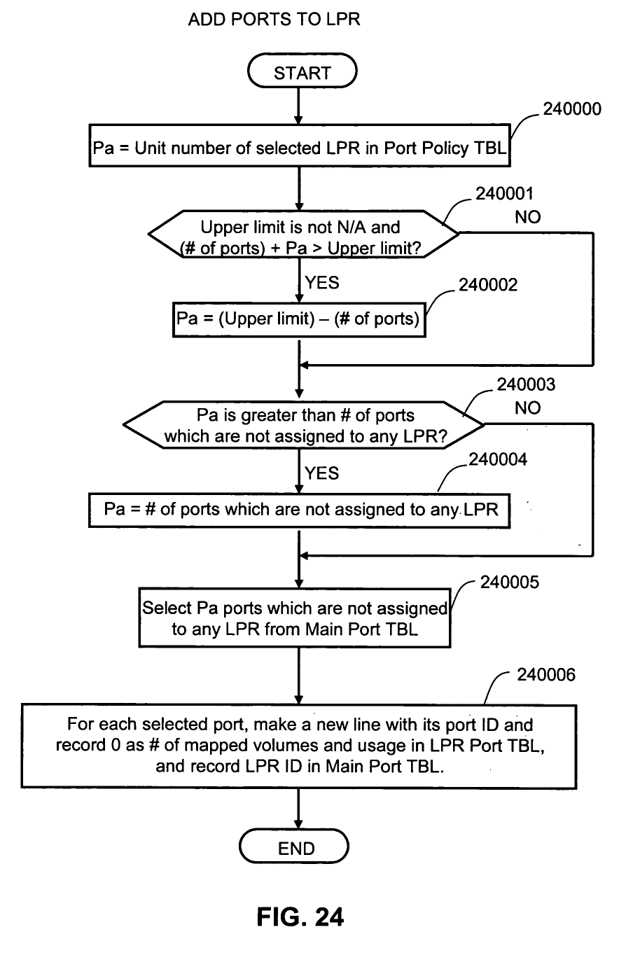

The details of the process of step 230003 for adding ports to an LPR are illustrated in FIG. 24. Storage control program 10014 tries to add a specified number of ports in the ‘unit’ field 110006 in port policy table 10023 at a time (step 240000) if the total number of ports in the LPR does not exceed the total port upper limit (step 240001). If the number of ports which are not assigned to any LPR is less than the number of ports to be added (step 240003), storage control program 10014 assigns all of them (steps 240004-240006). Otherwise, the storage control program 10014 assigns the number of ports necessary to maintain the port policy by selecting the unassigned ports (step 240005) and for each selected port, creating a new entry in the LPR port table 10020 and recording the LPR ID in the main port table 10016 (step 240006).

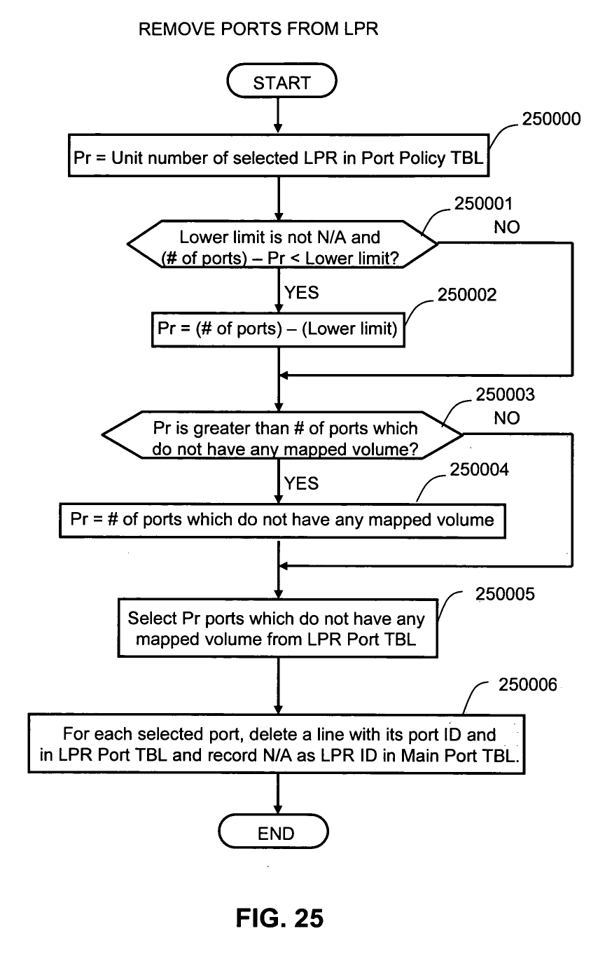

Further, the details of the process of step 230006 for removing ports from an LPR are illustrated in FIG. 25. Storage control program 10014 also tries to remove a specified number of ports in the ‘unit’ field in port policy table 10023 at a time (step 250000) unless the total number of ports in the LPR will become less than the total port lower limit (step 250001). If a volume is mapped to a port, the port is being used and cannot be removed from the LPR. So, ports to be removed must not have any mapped volume. If the number of ports which are not mapped to any port is less than the number of ports to be removed (step 250003), storage control program 10014 removes all of the ports which are not mapped by any volume. (step 240004-240006). Otherwise, storage control program 10014 selects ports to be removed which are not mapped by any volume (step 250005), and for each selected port, deletes the entry in the LPR port table 10020 and enters an “N/A” as the LPR ID in the main port table 10016.

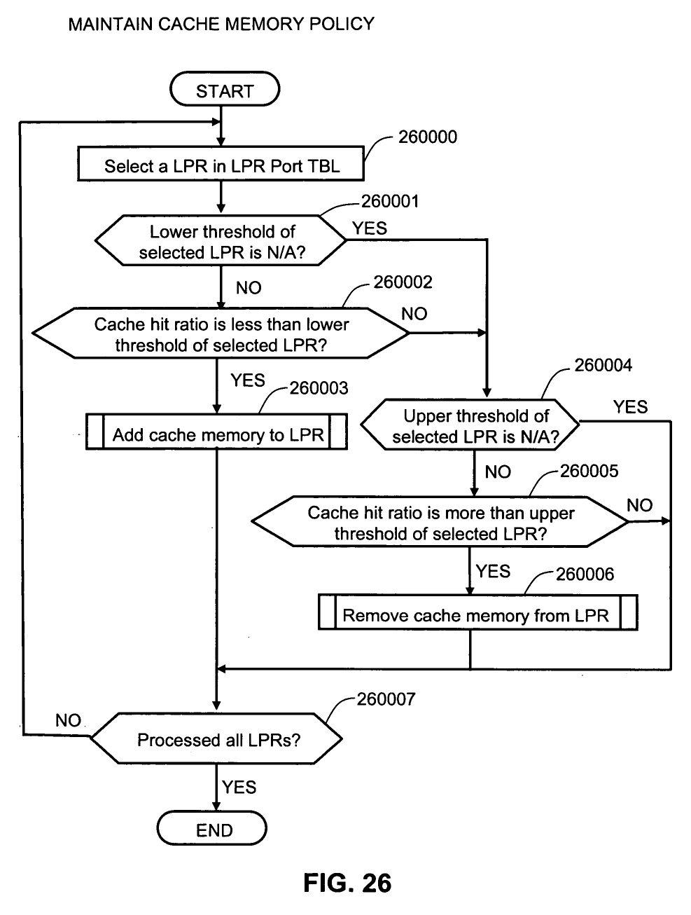

FIG. 26 illustrates the process flow for maintaining the cache memory policies for the LPRs. This process flow is similar to that set forth in FIG. 23 with respect to maintaining the port policies. For each selected LPR (step 260000), storage control program 10014 checks whether the upper and lower hit ratio thresholds are specified or not (steps 260001 and 260004, respectively). If the hit ratio lower threshold is specified and the cache hit ratio is less than the hit ratio lower threshold (step 260002), storage control program 10014 tries to add cache memory to the LPR (steps 260003). If the hit ratio upper threshold is specified and the cache hit ratio is more than the hit ratio upper threshold (step 260004), storage control program 10014 tries to remove cache memory from the LPR (steps 260006). The process repeats until all LPRs have been selected (step 260007).

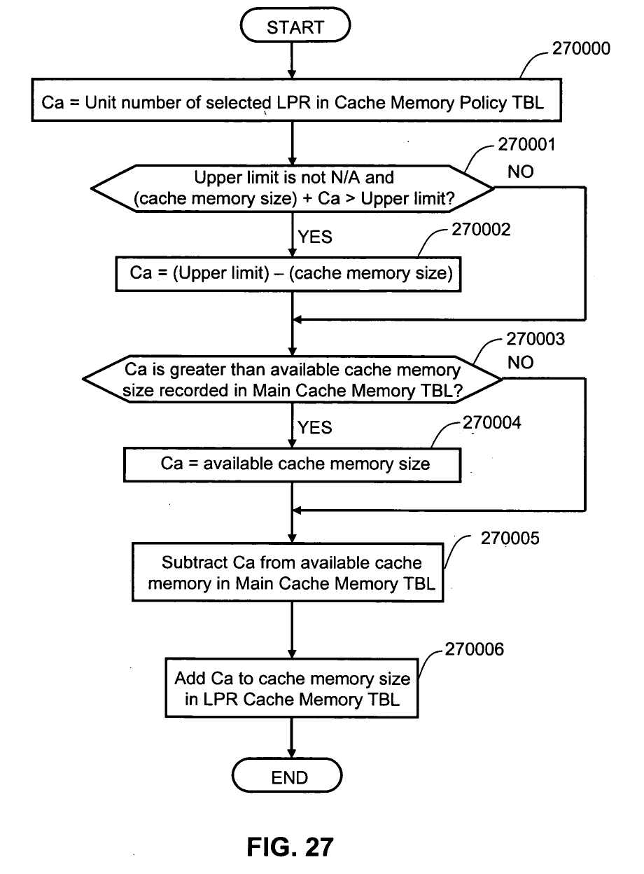

The details of the process of step 260003 for adding cache memory to an LPR are illustrated in FIG. 27. Storage control program 10014 tries to add specified amount of cache memory in accordance with cache policy table 10024 at a time (step 270000) if the total cache in the LPR does not exceed the cache size upper limit (step 270001). If the cache which is not assigned to any LPR is less than the cache required to be added (step 270003), storage control program 10014 assigns all of the available cache (steps 270004-270006). Otherwise, the storage control program 10014 assigns the amount of cache memory necessary to maintain the cache policy by subtracting the size of added cache memory from the available cache (step 270005) and adding the size to cache memory size in LPR cache memory table (step 270006).

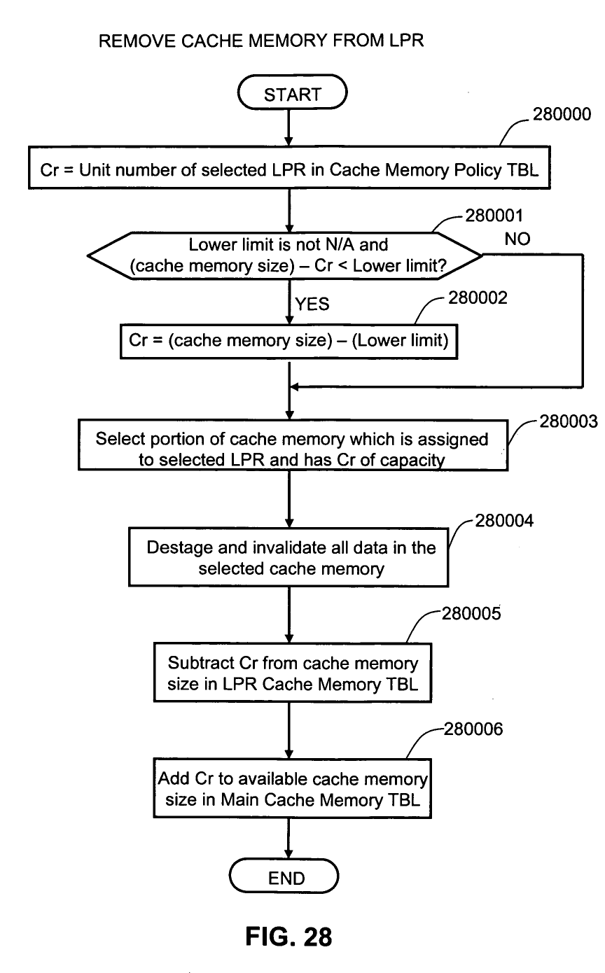

Further, the details of the process of step 260006 for removing cache memory from an LPR are illustrated in FIG. 28. Storage control program 10014 also tries to remove specified amount of cache memory at a time (step 280000) unless the total cache memory in the LPR will become less than the cache size lower limit (step 280001), in which case, only an amount of cache is removed to equal the lower limit (step 280002). All of the cache memory is always used, but it can be removed from an LPR by destaging data in the cache memory in advance. So, size of cache memory to be removed is not restricted (step 280003) in contrast to the case of ports, and the flow includes a step to destage the data (step 280004). Following destaging, storage control program 10014 subtracts the required amount of cache from the cache in the LPR cache memory table (step 280005), and adds the subtracted cache to the available cache memory in the main cache memory table 10017 (step 280006).

By using the means described above, resources in each LPR are automatically distributed and maintained in-line with the specified policies so that administrators do not have to perform a large number of manual operations. In the exemplary embodiment, storage capacity is managed as disk volumes. However, it is also possible to manage the capacity in various units like disk drives, RAID groups, etc.

Thus, the invention provides a method and system to automatically manage and apportion storage resources, such as storage capacity, ports, and cache memory in logically-partitioned storage systems based on the results of storage management operations, I/O statistics, and user-defined policies that may be pre-specified as conditions of operation for one or more of the logical partitions.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of automatically assigning resources to a logical partition (LPR) comprising the steps of:
monitoring resources assigned to each LPR;
determining how resources are being used by each LPR; and
based upon a predetermined condition, automatically removing a resource from one of said LPRs or assigning a resource to one of said LPRs.

2. The method according to claim 1, wherein the predetermined condition is based upon input/output (I/O) statistics.

3. The method according to claim 1, wherein the predetermined condition is based upon user-defined policies.

4. The method according to claim 1, wherein the resource is an amount of cache memory and the predetermined condition is based upon a determined cache hit ratio.

5. The method according to claim 2, wherein the I/O statistics include port usage or cache usage.

6. The method according to claim 1, wherein the user defined policies include a threshold for volume capacity in at least one of said LPRs.

7. A method for managing resources in a storage system having a plurality of logical partitions, wherein the partitioned resources for each logical partition comprise an amount of cache memory, at least one port, and at least one storage volume, said method comprising:
establishing one or more specified conditions for at least one of said resources; and
providing a program on a computer-readable medium, said program carrying out the steps of:
periodically monitoring states of the resources in one or more of said logical partitions
comparing the monitored states with the specified conditions; and
adjusting the resources of one or more of said logical partition to maintain the monitored states of the resources in accordance with the specified conditions.

8. The method of claim 7, further including the step of:
establishing a specified condition based on input/output statistics.

9. The method of claim 7, further including the step of:
establishing a specified condition based on capacity of one or more volumes apportioned to one of said logical partitions.

10. The method of claim 7, further including the step of:
establishing a specified condition based upon usage of one or more ports apportioned to one of said logical partitions.

11. The method of claim 7, further including the step of:
establishing a specified condition based upon usage of the apportioned cache memory for one or more of said logical partitions.

12. The method of claim 9, further including the step of:
adding one or more volumes to one of said logical partitions if a monitored state of volume capacity for that logical partition is less than a specified condition for volume capacity, or removing one or more volumes from one of said logical partitions if the monitored state of volume capacity for that logical partition is more than a specified condition for volume capacity.

13. The method of claim 10, further including the step of:
adding one or more ports to one of said logical partitions if a monitored state of port usage for that logical partition is greater than a specified condition for port usage, or removing one or more ports from one of said logical partitions if the monitored state of port usage for that logical partition is less than a specified condition for port usage.

14. The method of claim 11, further including the step of:
adding cache memory to one of said logical partitions if a monitored state of cache memory hit ratio for that logical partition is less than a specified condition for cache memory hit ratio, or removing cache memory from one of said logical partitions if the monitored state of cache memory hit ratio for that logical partition is greater than a specified condition for cache memory hit ratio.

15. A storage system comprising:
a cache memory;
a plurality of ports;
a plurality of storage devices for use in creating one or more volumes;
said storage system having one or more logical partitions of resources, wherein the resources include an amount of cache memory, at least one port, and at least one volume; and
a storage control program stored on a computer-readable medium and executable for managing said resources; whereby
one or more conditions for apportioning resources for each logical partition are specified,
the storage control program monitors whether the specified conditions are maintained, and
the storage control program adjusts apportionment of resources among the one or more logical partitions should the result of the monitoring indicate that the one or more specified conditions are not being maintained.

16. The storage system of claim 15, wherein:
a specified condition is based on input/output statistics.

17. The storage system of claim 15, wherein:
a specified condition is based on capacity of one or more volumes apportioned to one of said logical partitions.

18. The storage system of claim 15, wherein:
a specified condition is based upon usage of one or more ports apportioned to one of said logical partitions.

19. The storage system of claim 15, wherein:
a specified condition is based upon usage of the apportioned cache memory for one or more of said logical partitions.
